(19) United States
(12) Patent Application Publication
(10) Pub. No.: US 2019/0301559 A1
(43) Pub. Date: Oct. 3, 2019

(54) FRICTION SHOCK ABSORBER

(71) Applicant: Aleh Nicolaevich Halavach, Bobruisk (BY)

(72) Inventor: Aleh Nicolaevich Halavach, Bobruisk (BY)

(21) Appl. No.: 16/339,165

(22) PCT Filed: Jan. 27, 2017
(86) PCT No.: PCT/BY2017/000003

§ 371 Date: Apr. 3, 2019

(30) Foreign Application Priority Data
Oct. 3, 2016 (EA) 2016/EA/0074

(51) Int. Cl. F16F 13/00; F16F 7/09; B61G 11/14

(52) U.S. Cl. CPC F16F 13/005; B61G 11/14; F16F 7/09

(57) ABSTRACT

The present invention relates to the field of transport mechanical engineering.

Object—improve performance and operational reliability of a friction shock absorber.

It (FIG. 2) comprises housing (1) with internal protuberances, base (3), and orifice (6), wherein friction assembly (7) is situated that consists of pressure wedge (8) and stay wedges (9) contacting therewith, which wedges are in contact with guide plates (10) and movable plates (11) contacting therewith. The movable plates and stay wedges are in contact with pressure plate (12), between whereof and the base return-and-retaining device (14) is located contacting the carrying edge with its peak (15).

Part (A) of the return-and-retaining device is situated between the guide plates resting against the housing's internal protuberances fitted out with recesses (21) that may run along the entire width of the guide plates.

Width (B) of its Part (A) located between the recesses is bigger than the shortest distance (C) between the guide plates. The guide plates are located closer to the housing base than the pressure plate's carrying end contacting the peak of the return-and-retaining device.

The invention relates to the field of transport mechanical engineering and concerns friction shock absorbers for vehicles, primarily shock-absorbing devices, installed between cars of a railway train.

A friction shock absorber is known in the art [1, U.S. Pat. No. 7,540,387, IPC F16F7/08, B61G9/00 priority date Oct. 8, 2011, publication date 28 Oct. 2014], comprises a friction assembly within its housing that consists of a pressure wedge, stay wedges, movable plates, and guide plates. The friction assembly rests against the return-and-retaining device represented by metal springs installed on the housing base.

Such friction assembly lacks power capacity and performance, which is conditioned by the low force wherewith the stay wedges are pressed to the movable plates and guide plates. The lack of performance is due to the fact that the return-and-retaining device occupies a space under the friction assembly only, wherein higher-stiffness springs cannot be positioned.

The said problem is solved by the prior art friction shock absorber [2, Patent RU RU2338100, IPC F16F7/08, B61F5/12, B61G11/14, priority date 18 Apr. 2006, published on Oct. 11, 2008].

It comprises a housing, on the base whereof there is a return-and-retaining device represented by a box of resilient-elastic elements contacting the friction assembly that consists of a pressure wedge, stay wedges, guide plates, and movable plates. The streamlined design of the friction assembly allows to position a higher and stiffer return-and-retaining device inside the housing. This enables to improve the friction shock absorber's power capacity and performance.

However, such improvement in the stiffness of the return-and-retaining device affects the device's reliability. At the end of the maximum compression stroke of the return-and-retaining device, the separating and friction-induced forces experience an increase causing the surfaces of its parts to clamp together or stick up. In most cases, clamping occurs between the friction surfaces of the pressure wedge and those of stay wedges, or between those of stay wedges and of guide plates, or between all the above parts simultaneously. As a result, upon relief the clamped surfaces either disengage with big delay or cannot disengage at all, for the disengagement force exerted by the return-and-retaining device proves to be insufficient to overcome the mutual clamping forces holding the engaged friction assembly parts. It means that the friction shock absorber appears to be either jammed for some time, which affects its operability, or fully stalled and completely inoperable.

Furthermore, another shortcoming of the prior art friction shock absorber [2], as it is also the case with the closest prior art friction shock absorber [1], is that as they get closer to the end of the compression stroke of their return-and-retaining device, a part of the stay wedges hangs down over the friction surfaces of the guide plates with which they come in contact. This occurs in the closest prior art shock absorber [1] due to the fact that the guide plate is too short, while in the prior art shock absorber [2] this happens because there are some recesses on long guide plates closer to its housing base. Although in the prior art shock absorber [2] it is quite useful to reduce the final force growth rate upon maximum compression of the friction shock absorber's return-and-retaining device, such hanging of a part of stay wedges outside the friction surface of guide plates causes their contact area to reduce and the specific pressure to increase. This may cause the closest edge of guide plates friction surfaces adjoining the housing base to gradually deteriorate, encourage further development of such damage (cracks, spelling) along the guide plates, and occurrence of similar damage on the stay wedges as well.

The foregoing disadvantages of the prior art friction shock absorber [2] affect its performance and, especially, operational reliability.

Therefore, the goal of this invention is to improve performance and operational reliability of the friction shock absorber by improving its power capacity and lifespan, respectively, through achievement of the engineering result that would prevent the surfaces of the friction assembly from clamping together or sticking up, and make it possible to install a more powerful return-and-retaining device.

The above goal is solved in the invention by the fact that the friction shock absorber comprising a housing with internal protuberance and a base, and an orifice created by its wide and narrow walls, wherein the friction assembly is situated, which consists of a pressure wedge and stay wedges in contact therewith, which wedges are in contact with the guide plates and the movable plates contacting therewith, wherein the movable plates and the stay wedges come in contact with the pressure plate, between the carrying end and the base whereof there is a return-and-retaining device contacting the carrying end with its peak, while the movable plates come in contact with the walls of the housing orifice and are fitted out with side protuberances, and, moreover, a part of the return-and-retaining device is situated between the guide plates resting on the housing's internal protuberances, has the following distinctive features: the guide plates are fitted out with recesses facing the return-and-retaining device, while the width of its part situated between such recesses is bigger than the shortest distance between the guide plates, and, moreover, the guide plates are situated closer to the housing base than the pressure plate's carrying end that contacts the return-and-retaining device's peak.

The introduction by this invention of such distinctive features helps to avoid reciprocal clamping and sticking up of the friction assembly's surfaces, as well as to reduce the contact area in the middle part of the stay wedges and guide plates. This enables installation into the friction shock absorber of a highly powerful return-and-retaining device of higher stiffness due to the shock absorber's larger size and volume, and to lower the final force generated by the maximum compression of the friction shock absorber's return-and-retaining device, which increases the power capacity and lifespan, and, therefore, improves the performance and operational reliability of such an impact energy absorbing apparatus.

Additional distinctive features of the invention:
the pressure wedge rests against the additional return-and-retaining device;
hard lubricant inserts are available in the guide plates;
the friction assembly is secured by resting the hitches on the pressure wedge against the protuberances on the housing orifice;
the protuberances on the housing orifice are dislocated with respect to the middle of the orifice's wide walls;
a through hole is available in the pressure wedge;
the housing walls are partially formed by the inserts situated therein;
recesses are available along the entire width of the guide plates.

The invention is further described in detail with reference to the accompanying figures, wherein:

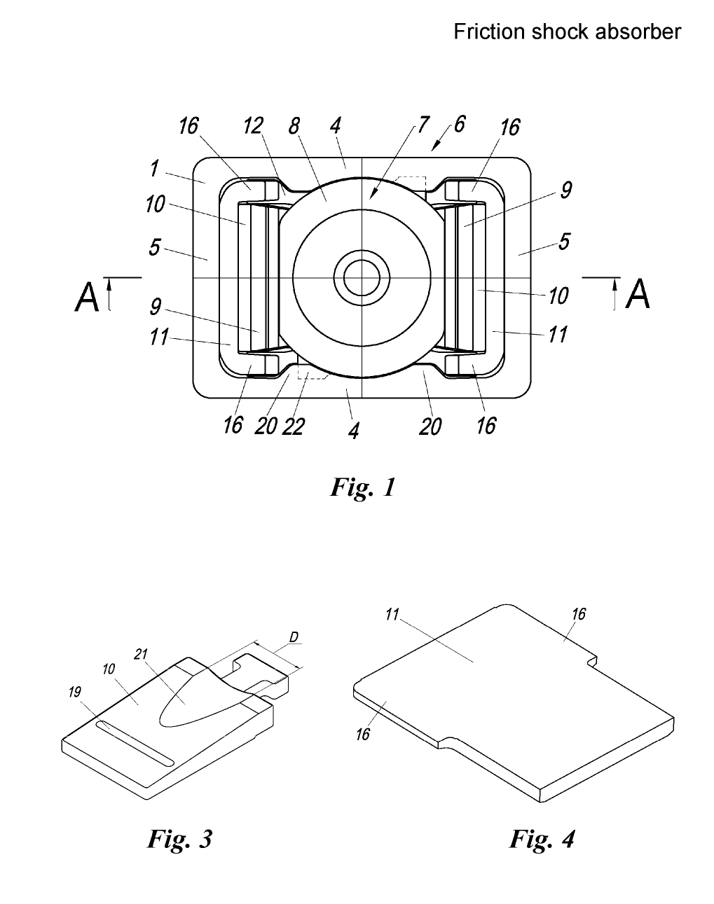

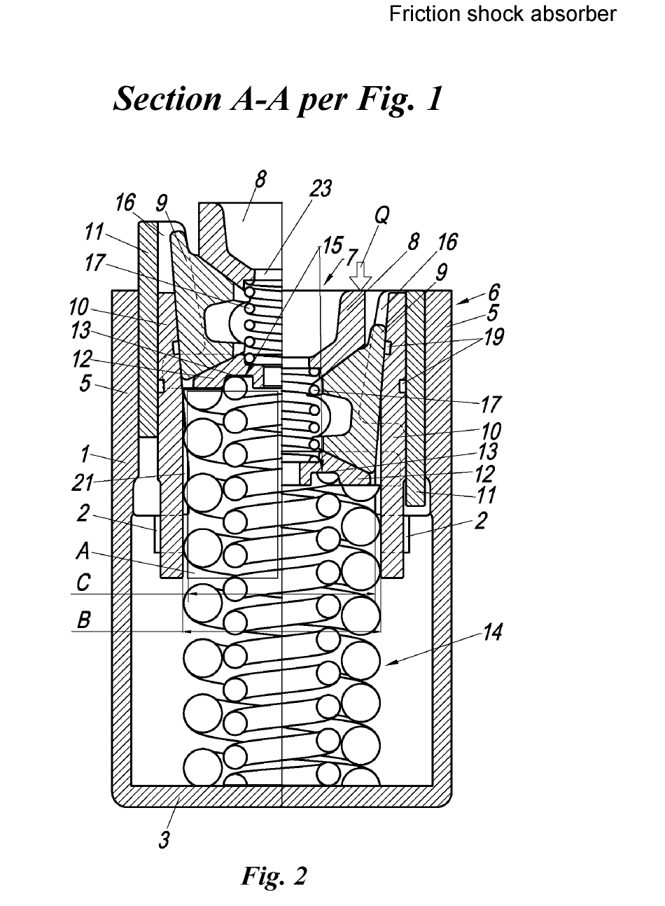

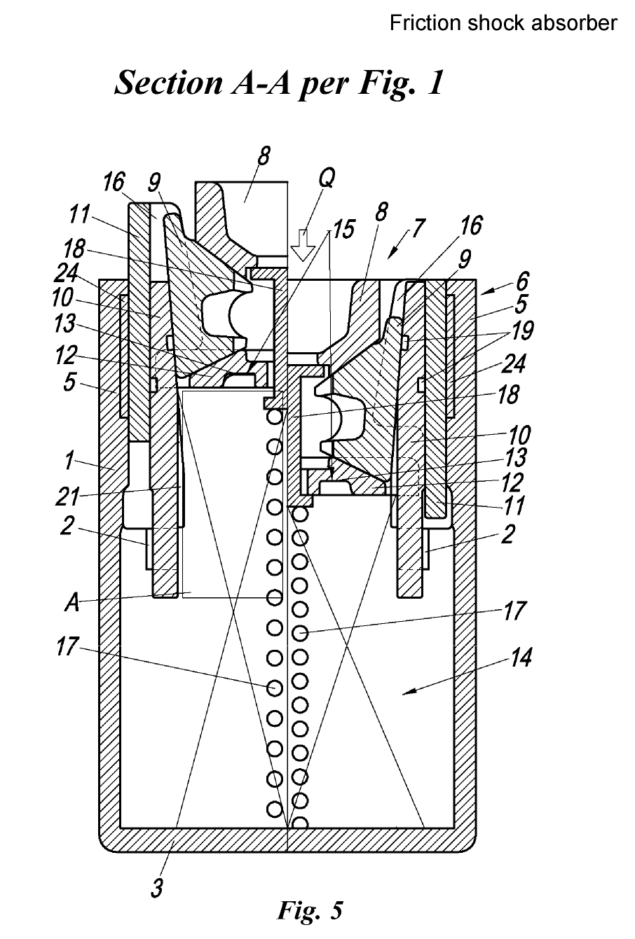

FIG. 1 shows the top view of the friction shock absorber according to the invention;

FIG. 2 shows integrated frontal section A-A per FIG. 1, wherein on the left-hand side the friction shock absorber is shown in its original position, while on the right-hand side it is demonstrated in its compressed state;

FIG. 3 shows the general view of the guide plate according to the invention;

FIG. 4 shows the general view of the movable plate embodiment;

FIG. 5 shows frontal section A-A per FIG. 1 in the embodiment of the additional return-and-retaining device and housing walls.

The friction shock absorber in its embodiments (FIG. 1, 2, 5) comprises housing 1 with internal protuberances 2 (FIG. 2, 5), and base 3. Housing 1 comprises orifice 6 (FIG. 1, 2, 5) formed by its wide 4 (FIG. 1, 2, 5) and narrow 5 (FIG. 2, 5) walls, wherein friction assembly 7 is situated that consists of pressure wedge 8 and stay wedges 9 contacting therewith. Stay wedges 9 are in contact with guide plates 10 (FIG. 1, 2, 3, 5) that are in contact with movable plates 11. (FIG. 1, 2, 4, 5). Movable plates 11 and stay wedges 9 are in contact with pressure plate 12 (FIG. 2, 5).

Return-and-retaining device 14 contacting carrying end 13 with its peak 15 is situated between carrying end 13 of pressure plate 12 and base 3 (FIG. 2, 5), while movable plates 11 (FIG. 1, 2, 5) are in contact with walls 5 of orifice 6 of housing 1 and have side protuberances 16. Part A (FIG. 2, 5) of return-and-retaining device 14 is situated between guide plates 10 resting on the housing's internal protuberances 2.

Movable plates 11 are located on pressure plate 12 (as shown in FIG. 1 and in dotted lines on FIG. 2) with their side protuberances 16. The side protuberances may also be designed as shown in FIG. 1, 2, and may have another design, as per FIG. 4.

In order to assist friction assembly 7 to settle in its initial position, it is useful to have pressure wedge 8 resting against the additional return-and-retaining device (FIG. 2) designed, for example, as metal compression spring 17 resting against pressure plate 12.

Another embodiment of the additional return-and-retaining device may also involve the use of longer metal compression spring 17 (FIG. 15). In this case, pressure wedge 8 is supported by flap 18 passing through pressure plate 12, while such metal compression spring 17, this time a longer one, is situated right between flap 18 and base 3 of housing 1.

The use in friction shock absorber, in its two embodiments (FIGS. 2 and 5), of an additional return-and-retaining device in the form of metal compression springs 17 between the pressure wedge and the pressure plate (FIG. 2) or between base 3 and flap 18 (FIG. 5) enables to improve its reliability, and to use return-and-retaining device 14 of higher stiffness compared to the closest prior art [1] and prior art [2] friction shock absorber designs. This will improve the power capacity and, therefore, the performance of such an impact energy absorbing device with no jamming risk involved.

In order to have smoother and more stable performance features of the friction shock absorber, and, at the same time, to minimize the wear of guide plates 10, as well as stay wedges 9 and movable plates 11 contacting therewith, it is useful to install hard lubricant inserts 19 into guide plates 10 (FIG. 2, 3, 5).

Recesses 21 (FIG. 2, 3, 5) are available on guide plates 10. Recesses are of D width that depends on the dimensions and shape of return-and-retaining device 14. At the same time, the shape must be sufficient to accommodate return-and-retaining device 14 and not prevent its operation. Therefore, one of the possible embodiments (not shown) is that where recesses (21) of guide plates (10) may be available along the entire width of guide plates (10).

Part A of return-and-retaining device 14 is situated between recesses 21 (FIG. 2, 5). Its width B is greater than minimal distance C between guide plates 10 (FIG. 2), which enables to install a highly powerful high-stiffness return-and-retaining device into the friction shock absorber, for example, as it is shown, in the form of a higher-stiffness spring with a lower-stiffness spring inserted therein.

Friction assembly 7 is secured by resting hitches 22 (shown in dotted lines in FIG. 1) on pressure wedge 8 into teeth 20 of orifice 6 of housing 1. Another securing option is possible, without teeth 20 and hitches 22, using a pinch bolt fastened into base 3 of housing 1 that has a nut crewed onto it from the side of pressure wedge 8 (not shown), as it is used in the prior art shock absorber [2].

Teeth 20 (FIG. 1) on orifice 6 must be displaced in relation to the middle of wide wall 4 of housing 1, which enables to easily fit return-and-retaining device of maximum possible dimensions into orifice 6 (FIG. 2, 5).

One of the specific features of housing 1 of the friction shock absorber according to the invention is that no process holes are required in walls 4, 5 for assembly purposes as it is the case with the closest prior art friction shock absorber [1]. This adds high strength to housing 1 of the friction shock absorber according to the invention, and leaves no weak points in its walls. In this case, for assembly purposes it has through hole 23 (FIG. 2) in pressure wedge 8, through which the device's rod is passed (not shown).

The rod rests with its end against pressure plate 12. Application of force against the device's rod results in the compression of return-and-retaining device 14, thus leaving empty space to place other parts of friction assembly 7. As soon as the force is released from the rod, the friction shock absorber becomes assembled. This assembly process appears to be safer and simpler than the one used for assembly of closest prior art [1] and prior art [2] friction shock absorbers.

The design of the friction shock absorber's elements, as described above, aims to reduce the final force at maximum compression of return-and-retaining device 14 due to a smaller contact area in the middle part of stay wedges 9 and guide plates 10, rather than due to the hanging of the stay wedge's part that is the closest to the housing base outside the friction surfaces of the guide plates, as it is done in prior art shock absorber [2]. At the same time, guide plates 10 can be made long enough to make sure the position of stay wedges 9 is very stable in relation thereto, which is not the case in closest prior art [1] and prior art [2] friction shock absorbers due to insufficient reciprocal contact between the guide plates when hanging occurs at the end of the stroke.

As it was mentioned above, return-and-retaining device 14 may be designed, for example, in the form of metal compression springs inserted into each other (FIG. 2). It may also be designed (not shown) as a package of resilient-elastic elements, as it is the case in prior art shock absorber [2].

In order to avoid premature wear of walls 5 of housing 1 on the side of movable plates 11, it is useful for walls 5 of housing 1 to be partially formed by inserts 23 (FIG. 5) situated therein and made of more wear-resistant material than that of which housing 1 is made. At the same time, replacement of worn inserts after long operation of a friction shock absorber represents a quicker and simpler process repair operation compared to the more complex, longer and, on some occasions, impracticable restoration, for example, by pad welding followed by processing of worn housing 1 walls in closest prior art [1] and prior art [2] friction shock absorbers.

The operating principle of the friction shock absorber is based on the fact that return-and-retaining device 14 is compressed when external force Q (FIG. 2, 5, right-hand side halves of the figures) is applied to pressure wedge 8, e.g. at the side of the drawbar (not shown), when the cars collide (not shown). Friction assembly 7 is buried into orifice 6 of housing 1. Pressure wedge 8 drags stay wedges 9 inside housing 1.

At a certain phase of the stroke, the pressure plate (not shown) of the car's automatic coupling device (not shown) begins pressing movable plates 11. When exposed to this force, they enter into housing 1 along guide plates 10 and walls 5 experiencing friction.

When external force Q is released, additional return-and-retaining device pushes pressure wedge 6 away from stay wedges 9, helping them return to their original position. As a result, return-and-retaining device 14 can release in a much easier way, pushing pressure plate 12 back into its original position along with friction assembly 7 installed thereon.

### REFERENCES

1. U.S. Pat. No. 7,540,387, IPC F16F7/08, B61G9/00, priority date 10 Aug. 2011, publication date 28 Oct. 2014.
2. Patent RU2338100, IPC F16F7/08, B61F5/08, priority date 18 Apr. 2006, publication date 10 Nov. 2008/prior art/.

1. Friction shock absorber comprising housing (1) with internal protuberances (2) and base (3), and orifice (6) created by its wide (4) and narrow (5) walls, wherein friction assembly (7) is situated, which consists of pressure wedge (8) and stay wedges (9) in contact therewith, which wedges are in contact with guide plates (10) and movable plates (11) contacting therewith, wherein movable plates (11) and the stay wedges (9) come in contact with pressure plate (12), between carrying end (13) and base (3) whereof there is a return-and-retaining device (14) contacting the carrying end (13) with its peak (15), while movable plates (11) come in contact with walls (5) of orifice (6) of housing (1) and are fitted out with side protuberances (16), and, moreover, part (A) of return-and-retaining device (14) is situated between guide plates (10) resting on the internal protuberances (2) of housing (1), wherein guide plates (10) are fitted out with recesses (21) facing return-and-retaining device (14), while width (B) of its part (A) situated between such recesses (21) is bigger than the shortest distance (C) between guide plates (10), and, moreover, guide plates (10) are situated closer to base (3) of housing (1) than carrying end (13) of pressure plate (12) that contacts peak (15) of return-and-retaining device (14).

2. Shock absorber according to claim 1, wherein pressure wedge (8) rests against additional return-and-retaining device (17).

3. Shock absorber according to claim 1, wherein hard lubricant inserts (19) are available in guide plates (10).

4. Shock absorber according to claim 1, wherein friction assembly (7) is secured by resting hitches (22) on pressure wedge (8) against protuberances (20) in orifice (6) of housing (1).

5. Shock absorber according to claim 2, wherein protuberances (20) on orifice (6) of housing (1) are dislocated in relation to the middle of wide walls (4) of orifice (6).

6. Shock absorber according to claim 1, wherein through hole (23) is available in pressure wedge (8).

7. Shock absorber according to claim 1, wherein walls (5) of housing (1) are partially formed by inserts (24) situated therein.

8. Shock absorber according to claim 1, wherein recesses (21) are available along the entire width of guide plates (10).
